(19) United States
(12) Patent Application Publication
(10) Pub. No.: US 2014/0013804 A1
(43) Pub. Date: Jan. 16, 2014

(54) PROCESS AND APPARATUS FOR PRODUCING GLASS MEMBER PROVIDED WITH SEALING MATERIAL LAYER AND PROCESS FOR PRODUCING ELECTRONIC DEVICE

(71) Applicant: ASAHI GLASS COMPANY, LIMITED, Chiyoda-ku (JP)

(72) Inventors: Motoshi ONO, Chiyoda-ku (JP); Sohei Kawanami, Chiyoda-ku (JP)

(73) Assignee: ASAHI GLASS COMPANY, LIMITED, Chiyoda-ku (JP)

(21) Appl. No.: 13/936,590

(22) Filed: Jul. 8, 2013

Related U.S. Application Data
(63) Continuation of application No. PCT/JP2012/050108, filed on Jan. 5, 2012.

(30) Foreign Application Priority Data
Jan. 6, 2011 (JP) 2011-001290
Aug. 2, 2011 (JP) 2011-169072

(51) Int. Cl. C03B 23/24

(52) U.S. Cl. CPC C03B 23/245
USPC 65/43; 65/60.5; 65/163

(57) ABSTRACT

To provide a process for producing a glass member provided with a sealing material layer, capable of forming a sealing material layer well even in a case where the entire glass substrate cannot be heated. A sealing material layer is formed by scanning and irradiating with a laser light 9 along a frame-form coating layer 8 of a sealing material paste on a glass substrate. The scanning speed with the laser light 9 in a finishing region from a position close to an irradiation finishing position which at least partially overlaps with an already fired portion of the frame-form coating layer 8 to the irradiation finishing position, is adjusted to be slower than the scanning speed with the laser light in a scanning region along the frame-form coating layer 8.

### TECHNICAL FIELD

The present invention relates to a process and an apparatus for producing a glass member provided with a sealing material layer, and a process for producing an electronic device.

### BACKGROUND ART

A flat panel display (FPD) such as an organic EL (electro-luminescence) display (OELD), a field emission display (FED), a plasma display panel (PDP) or a liquid crystal display (LCD) has such a structure that a glass substrate for an element having a display element formed thereon and a glass substrate for sealing are disposed to face each other and the display element is sealed in a glass package comprising such two glass substrates hermetically bonded (Patent Document 1). Also, for a solar cell such as a dye-sensitized solar cell, application of a glass package having a solar cell element (photoelectric conversion element) sealed with two glass substrates has been studied (Patent Document 2).

As a sealing material to seal the space between two glass substrates, application of a sealing glass excellent in the moisture resistance, etc. is in progress. Since the sealing temperature by the sealing glass is at a level of from 400 to 600° C., properties of an electronic element portion of the OEL element, a dye-sensitized solar cell element or the like will be deteriorated when firing is conducted by using a heating furnace. Accordingly, it has been attempted that a sealing material layer containing a sealing glass and a laser absorbent is disposed between sealing regions provided on the peripheral portions of two glass substrates, and the sealing material layer is irradiated with a laser light to heat and melt the sealing material layer to conduct sealing (Patent Documents 1 and 2).

In a case where laser sealing is to be applied, first, a sealing material is mixed with a vehicle to prepare a sealing material paste, which is then applied to a sealing region of one glass substrate and heated to the firing temperature (a temperature of at least the softening temperature of the sealing glass) of the sealing material to melt the sealing glass and burn it on the glass substrate to form a sealing material layer. Further, in the process of heating the sealing material to the firing temperature, the organic binder is burnt out by thermal decomposition. Then, the glass substrate having the sealing material layer and the other glass substrate are laminated by means of the sealing material layer, and the laminate is then irradiated with a laser light from the side of one of the glass substrates to heat and melt the sealing material layer to seal in an electronic element portion provided between the glass substrates.

To form the sealing material layer, a heating furnace is commonly used. Patent Document 3 discloses to conduct a first heating procedure of removing the organic binder in forming the sealing material layer and a second heating procedure of baking the sealing material. In the first heating procedure, a glass substrate is heated from its rear side by means of a hot plate, an infrared heater, a heating lamp, a laser light or the like. In the second heating procedure, in the same manner as a conventional firing step, the entire glass substrate is heated by means of a heater in a heating furnace. In the process disclosed in Patent Document 3 also, baking of the sealing material is carried out by heating the entire glass substrate by means of a heating furnace.

By the way, for a glass package for FPD, an organic resin film such as a color filter is formed not only on a glass substrate for an element but also on a glass substrate for sealing. In such a case, if the entire substrate is heated in a heating furnace, the organic resin film will be damaged by heat, and accordingly a firing step by a common heating furnace cannot be applied even for the formation of the sealing material layer on the glass substrate for sealing. Further, in a dye-sensitized solar cell, an element film or the like is formed even on the facing substrate side, and it is required to suppress thermal deterioration of the element film or the like in the firing step. Further, since the firing step by a heating furnace usually requires a long time and consumes a lot of energy, improvement is required from the viewpoint of reducing the number of production steps and the production cost and also from the viewpoint of the energy saving.

Patent Document 4 discloses application of a sealing material made of a paste prepared by mixing low temperature melting glass (sealing glass), a binder and a solvent to one of panel substrates, followed by laser annealing to form a sealing material layer. However, when a laser anneal is applied, in the coating layer of a sealing material, an irradiation starting position and an irradiation finishing position with laser light at least partially overlap with each other, and it is therefore likely that upon completion of irradiation with laser light, the sealing glass undergoes shrinkage due to e.g. the surface tension or reduction of voids, whereby a relatively large gap (space) forms at the irradiation finishing position. The gap formed in the sealing material layer may cause a deterioration in the hermetical sealing properties of the glass package in the subsequent laser sealing step.

### PRIOR ART DOCUMENTS

### Patent Documents

Patent Document 1: JP-A-2006-524419
Patent Document 2: JP-A-2008-115057
Patent Document 3: JP-A-2003-068199
Patent Document 4: JP-A-2002-366050

### DISCLOSURE OF INVENTION

### Technical Problem

It is an object of the present invention to provide a process and an apparatus for producing a glass member provided with a sealing material layer and a process for producing an electronic device, each of which makes it possible to form a good sealing material layer inexpensively with good reproducibility even in a case where the entire glass substrate cannot be heated.

### Solution to Problem

The process for producing a glass member provided with a sealing material layer of the present invention comprises preparing a glass substrate having a sealing region; applying a sealing material paste prepared by mixing a sealing material containing a sealing glass and a laser absorbent with an organic binder, to the sealing region of the glass substrate in the form of a frame to form a frame-form coating layer; and scanning and irradiating along the frame-form coating layer of the sealing material paste with a laser light to heat the entire frame-form coating layer with the laser light thereby to fire the sealing material while burning off the organic binder in the frame-form coating layer to form a sealing material layer;

wherein the scanning speed with the laser light in a finishing region from a position close to an irradiation finishing position which at least partially overlaps with an already fired portion of the frame-form coating layer to the irradiation finishing position, is adjusted to be slower than the scanning speed with the laser light in a scanning region along the frame-form coating layer excluding the finishing region.

The apparatus for producing a glass member provided with a sealing material layer of the present invention comprises a sample table on which a glass substrate having a frame-form coating layer of a sealing material paste prepared by mixing a sealing material containing a sealing glass and a laser absorbent with an organic binder, is to be placed; a laser light source to emit a laser light; a laser irradiation head having an optical system to irradiate the frame-form coating layer of the glass substrate with a laser light emitted from the laser light source; a power control part to control the power of the laser light to be applied to the frame-form coating layer from the laser irradiation head; a moving mechanism to relatively change the positional relation between the sample table and the laser irradiation head; a scanning control part to control the moving mechanism so as to apply the laser light with scanning along the frame-form coating layer and to adjust the scanning speed with the laser light in a finishing region from a position close to an irradiation finishing position which at least partially overlaps with an already fired portion of the frame-form coating layer to the irradiation finishing position, to be slower than the scanning speed with the laser light in a scanning region along the frame-form coating layer excluding the finishing region.

The process for producing an electronic device of the present invention comprises preparing a first glass substrate having a first surface having a first sealing region provided thereon; preparing a second glass substrate having a second surface having a second sealing region corresponding to the first sealing region provided thereon; applying a sealing material paste prepared by mixing a sealing material containing a sealing glass and a laser absorbent with an organic binder to the second sealing region of the second glass substrate in the form of a frame to form a frame-form coating layer; scanning and irradiating with a firing laser light along the frame-form coating layer of the sealing material paste to heat the entire frame-form coating layer with the laser light thereby to fire the sealing material while burning off the organic binder in the frame-form coating layer to form a sealing material layer; laminating the first glass substrate and the second glass substrate via the sealing material layer so that the first surface and the second surface face each other; and irradiating the sealing material layer with a sealing laser light through the first glass substrate or the second glass substrate to melt the sealing material layer thereby to form a sealing layer to seal an electronic element portion provided between the first glass substrate and the second glass substrate; wherein in irradiating the sealing material layer, the scanning speed with the laser light in a finishing region from a position close to an irradiation finishing position which at least partially overlaps with an already fired portion of the frame-form coating layer to the irradiation finishing position, is adjusted to be slower than the scanning speed with the laser light in a scanning region along the frame-form coating layer excluding the finishing region.

In this process for producing an electronic device, the “preparing a first glass substrate” and the “preparing a second glass substrate” may be carried out in the above-mentioned order or in the reversed order, or may be carried out simultaneously in parallel. The subsequent “laminating the first glass substrate and the second glass substrate” and “irradiating the sealing material layer” are carried out in this order.

### Advantageous Effects of Invention

According to the process for producing a glass member provided with a sealing material layer according to an embodiment of the present invention, a good sealing material layer can be formed inexpensively with good reproducibility even in a case where the entire glass substrate cannot be heated. Accordingly, even in a case where such a glass substrate is used, an electronic device excellent in the reliability, the sealing property, etc. can be produced inexpensively.

### BRIEF DESCRIPTION OF DRAWINGS

FIGS. 1A-D are cross-sectional views illustrating the processing states at the respective stages in the process for production of an electronic device according to an embodiment of the present invention.

FIG. 2 is a plan view illustrating a first glass substrate to be used in the process for production of an electronic device shown in FIGS. 1A-D.

FIG. 3 is a cross-sectional view along the line A-A in FIG. 2.

FIG. 4 is a plan view illustrating a second glass substrate to be used in the process for production of an electronic device shown in FIGS. 1A-D.

FIG. 5 is a cross-sectional view along the line A-A in FIG. 4.

FIGS. 6 A-C are cross-sectional views illustrating the process for forming a sealing material layer on the second glass substrate in the process for production of an electronic device shown in FIGS. 1A-D.

FIG. 7 is a view illustrating an example of scanning with laser light in the process for forming a sealing material layer in an embodiment of the present invention.

FIGS. 8A-D are views illustrating an irradiation starting position with laser light in the process for forming a sealing material layer in an embodiment of the present invention.

FIGS. 9A-B are views illustrating an irradiation finishing position with laser light in the process for forming a sealing material layer in the embodiment of the present invention.

FIGS. 10A-D are views illustrating the scanning speed in a finishing region with laser light in the process for forming a sealing material layer in the embodiment of the present invention.

FIG. 11 is a schematic plan view illustrating an apparatus for producing a glass member provided with a sealing material layer according to an embodiment of the present invention.

FIG. 12 is a schematic front view of the apparatus for producing a glass member provided with a sealing material layer shown in FIG. 11.

FIG. 13 is a schematic view illustrating the structure of a laser irradiation head in the process for producing a glass member provided with a sealing material layer according to an embodiment of the present invention.

### DESCRIPTION OF EMBODIMENTS

Now, the embodiments of the present invention will be described with reference to drawings.

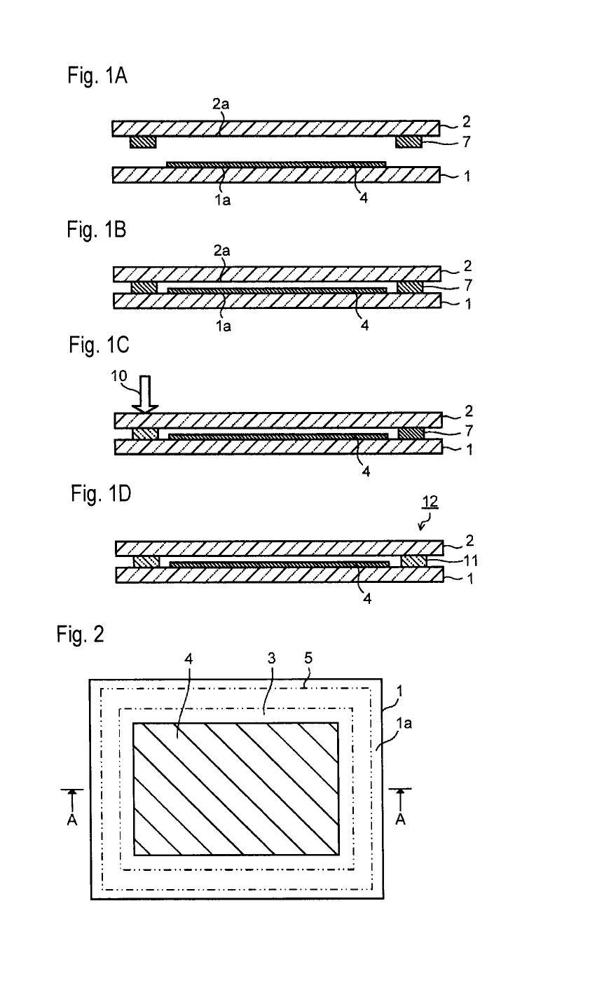

FIGS. 1 to 6 are views illustrating the process for production of an electronic device according to an embodiment of the present invention. An electronic device to which the production process according to the embodiment of the present invention is applied may be a FPD such as an OELD, a FED, a PDP or a LCD, an illumination apparatus employing a light-emitting element such as an OEL element, or a sealed type solar cell such as a dye-sensitized solar cell, a thin film silicone solar cell or a compound semiconductor solar cell.

First, as shown in FIG. 1A, a first glass substrate 1 and a second glass substrate 2 are prepared. For the first and second glass substrates 1 and 2, a glass substrate formed by e.g. alkali-free glass or soda lime glass having a known composition may, for example, be used. Alkali-free glass has a thermal expansion coefficient at a level of from 35 to 40×10⁻⁷/K. Soda lime glass has a thermal expansion coefficient at a level of from 80 to 90×10⁻⁷/K. A typical glass composition of alkali free glass may be one comprising, as represented by mass %, from 50 to 70% of SiO₂, from 1 to 20% of Al₂O₃, from 0 to 15% of B₂O₃, from 0 to 30% of MgO, from 0 to 30% of CaO, from 0 to 30% of SrO and from 0 to 30% of BaO, and a typical glass composition of soda lime glass may be one comprising, as represented by mass %, from 55 to 75% of SiO₂, from 0.5 to 10% of Al₂O₃, from 2 to 10% of CaO, from 0 to 10% of SrO, from 1 to 10% of Na₂O and from 0 to 10% K₂O. However, the glass compositions are not limited thereto. Further, at least one of the first and second glass substrates 1 and 2 may be chemically tempered glass or the like.

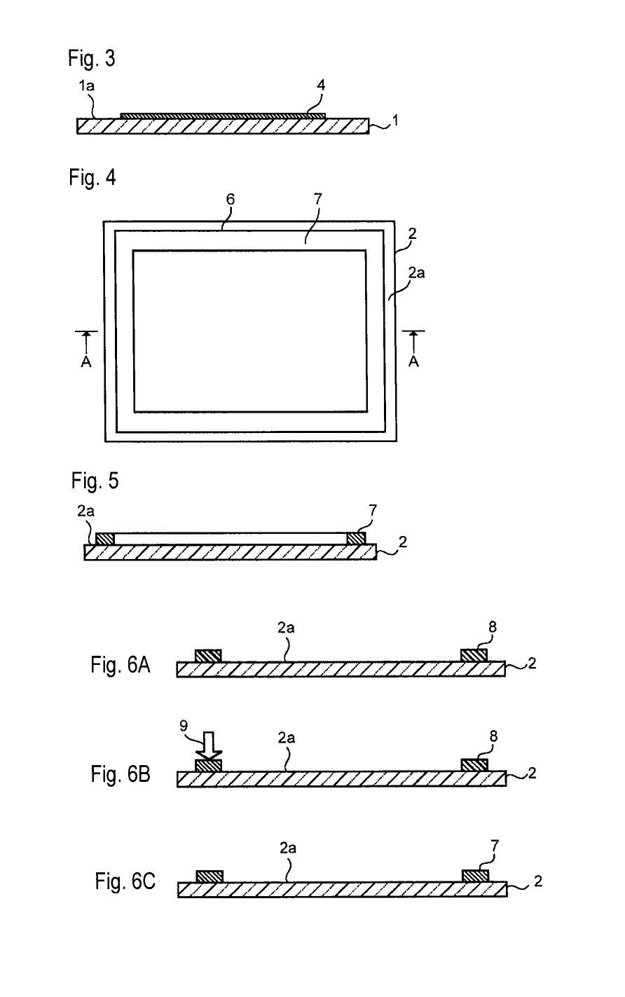

The first glass substrate 1 has a surface 1a having an element region 3 provided thereon as shown in FIGS. 2 and 3. On the element region 3, an electronic element portion 4 corresponding to an electronic device as an object is provided. The electronic element portion 4 is provided with an OEL element in the case of an OELD or an OEL illumination, an electron-emitting element in the case of FED, a plasma light-emitting element in the case of a PDP, a liquid crystal display element in the case of a LCD, or a solar cell element in the case of a solar cell. The electronic element portion 4 provided with a light-emitting element such as a liquid crystal element, a plasma light-emitting element or an OEL element, a display element such as a liquid crystal element or a solar cell element such as a dye-sensitized solar cell element or the like has a known structure. The element structure of the electronic element portion 4 is not particularly limited.

On the peripheral portion of the surface 1a of the first glass substrate 1, a frame-form first sealing region 5 is provided along the outer periphery of the element region 3. The first sealing region 5 is provided so as to surround the element region 3. The second glass substrate 2 has a surface 2a facing the surface 1a of the first glass substrate 1. On the peripheral portion of the surface 2a of the second glass substrate 2, a frame-form second sealing region 6 corresponding to the first sealing region 5 is provided as shown in FIGS. 4 and 5. The first and second sealing regions 5 and 6 correspond to regions on which a sealing layer is to be formed. The second sealing region 6 corresponds to a region on which a sealing material layer is to be formed on the second glass substrate 2.

The electronic element portion 4 is provided between the surface 1a of the first glass substrate 1 and the surface 2a of the second glass substrate 2. In the process for production of an electronic device as shown in FIGS. 1A-D, the first glass substrate 1 constitutes a glass substrate for an element, and has an element structure such as an OEL element or a PDP element formed as the electronic element portion 4 on the surface 1a. The second glass substrate 2 constitutes a glass substrate for sealing the electronic element portion 4 formed on the surface 1a of the first glass substrate 1. However, the structure of the electronic element portion 4 is not limited thereto.

For example, in a case where the electronic element portion 4 is a dye-sensitized solar cell element or the like, an element film such as a wiring film or an electrode film to form an element structure is formed on the surface 1a or 2a of the first or second glass substrate 1 or 2. The element film constituting the electronic element portion 4 and an element structure based thereon are formed on at least one of the surfaces 1a and 2a of the first and second glass substrates 1 and 2. Further, on the surface 2a of the second glass substrate 2 constituting the glass substrate for sealing, as described above, an organic resin film such as a color filter is formed in some cases.

On the second sealing region 6 of the second glass substrate 2, as shown in FIGS. 1A, 4 and 5, a frame-form sealing material layer 7 is formed along the entire or substantially entire peripheral portion of the second glass substrate 2. The sealing material layer 7 is a fired layer of a sealing material containing a sealing glass and a laser absorbent. The sealing material comprises a sealing glass as the main component and a laser absorbent, and as the case requires, an inorganic filler such as a low expansion filler may be incorporated. The sealing material may contain fillers and additives other than the above, as the case requires.

For the sealing glass (glass frit), for example, low temperature melting glass such as tin-phosphate glass, bismuth glass, vanadium glass or lead glass may be used. Among them, considering the sealing property (adhesion property) to the glass substrates 1 and 2 and the reliability (bonding reliability and hermetically sealing property) and in addition, the influences over the environment and the human body, it is preferred to use a low melting sealing glass comprising tin-phosphate glass or bismuth glass.

The tin-phosphate glass (glass frit) preferably has a composition comprising from 55 to 68 mol % of SnO, from 0.5 to 5 mol % of SnO₂ and from 20 to 40 mol % of P₂O₅ (basically the total amount will be 100 mol %).

SnO is a component to make the glass have a low melting point. If the content of SnO is less than 55 mol %, the viscosity of glass will be high and the sealing temperature will be too high, and if the content exceeds 68 mol %, the glass will not be vitrified.

SnO₂ is a component to stabilize glass. If the content of SnO₂ is less than 0.5 mol %, SnO₂ will be separated and precipitate in the glass softened and melted at the time of the sealing operation, and the fluidity will be impaired and the sealing operation property will be decreased. If the content of SnO₂ exceeds 5 mol %, SnO₂ is likely to precipitate in the melt of the low temperature melting glass. P₂O₅ is a component to form a glass skeleton. If the content of P₂O₅ is less than 20 mol %, the glass will not be vitrified, and if the content exceeds 40 mol %, deterioration of the weather resistance which is a drawback specific to phosphate glass may occur.

Here, the ratios (mol %) of SnO and SnO₂ in the glass frit can be determined as follows. First, the glass frit (low temperature melting glass powder) is subjected to acid decomposition, and then the total amount of Sn atoms contained in the glass frit is measured by ICP emission spectroscopy. Then, the amount of Sn²⁺ (SnO) can be obtained by the iodometric titration after the acid decomposition, and thus the amount of Sn⁴⁺ (SnO₂) is determined by subtracting the above obtained amount of Sn²⁺ from the total amount of the Sn atoms.

The glass formed by the above three components has a low glass transition point and is suitable as a sealing material at low temperature, and it may contain e.g. a component to form a glass skeleton such as SiO₂, or a component to stabilize the glass such as ZnO, B₂O₃, Al₂O₃, WO₃, MoO₃, Nb₂O₅, TiO₂, ZrO₂, Li₂O, Na₂O, K₂O, Cs₂O, MgO, CaO, SrO or BaO as an optional component. However, if the content of the optional component is too high, the glass will be unstable, whereby devitrification may occur, or the glass transition point or the softening point may be increased. Thus, the total content of the optional components is preferably at most 30 mol %. The glass composition in such a case is adjusted so that the total amount of the basic components and optional components is basically 100 mol %.

The bismuth glass (glass frit) preferably has a composition comprising from 70 to 90 mass % of Bi₂O₃, from 1 to 20 mass % of ZnO and from 2 to 12 mass % of B₂O₃ (basically the total content will be 100 mass %). Bi₂O₃ is a component to form a glass network. If the content of Bi₂O₃ is less than 70 mass %, the softening point of the low temperature melting glass will be high, whereby sealing at low temperature will be difficult. If the content of Bi₂O₃ exceeds 90 mass %, the glass will hardly be vitrified and in addition, the thermal expansion coefficient tends to be too high.

ZnO is a component to lower the thermal expansion coefficient or the like. If the content of ZnO is less than 1 mass %, the glass will hardly be vitrified. If the content of ZnO exceeds 20 mass %, the stability at the time of formation of the low temperature melting glass will be decreased, and devitrification is likely to occur. B₂O₃ is a component to form a glass skeleton and to broaden a range within which the glass can be vitrified. If the content of B₂O₃ is less than 2 mass %, the glass will hardly be vitrified, and if it exceeds 12 mass %, the softening point will be too high, whereby sealing at low temperature will be difficult even if a load is applied at the time of the sealing.

The glass formed by the above three components has a low glass transition point and is suitable as a sealing material at low temperature, and it may contain an optional component such as Al₂O₃, CeO₂, SiO₂, Ag₂O, MoO₃, Nb₂O₃, Ta₂O₅, Ga₂O₃, Sb₂O₃, Li₂O, Na₂O, K₂O, Cs₂O, CaO, SrO, BaO, WO₃, P₂O₅ or SnOx (wherein x is 1 or 2). However, if the content of the optional components is too high, the glass will be unstable, whereby devitrification may occur, or the glass transition point or the softening point may be increased. Thus, the total content of the optional components is preferably at most 30 mass %. The glass composition in such a case is adjusted so that the total amount of the basic components and optional components is basically 100 mass %.

The sealing material contains a laser absorbent. As the laser absorbent, at least one metal selected from Fe, Cr, Mn, Co, Ni and Cu, and/or at least one metal compound such as an oxide containing the above metal may be used. Further, a pigment other than the above e.g. a vanadium oxide (specifically VO, VO₂ and V₂O₅), may also be used. The content of the laser absorbent is preferably within a range of from 0.1 to 40 vol % to the sealing material. If the content of the laser absorbent is less than 0.1 vol %, the sealing material layer 7 may not sufficiently be melted. If the content of the laser absorbent exceeds 40 vol %, a portion in the vicinity of an interface with the second glass substrate 2 may locally generate heat, or the fluidity of the sealing material at the time of melting may be deteriorated, whereby the adhesion to the first glass substrate 1 may be decreased. The content is preferably at most 37 vol %.

In the present invention, the above-described sealing glass or glass frit, the laser absorbent and the low-expansion filler may, respectively, be in a powder form or a particle form. A sealing glass powder may simply be referred to as sealing glass or glass frit, and laser absorbent particles or laser absorbent powder may simply be referred to as a laser absorbent. Further, low-expansion filler particles or low-expansion filler powder may simply be referred to as a low-expansion filler.

Further, the sealing material may contain a low-expansion filler as the case requires. As the low-expansion filler, it is preferred to use at least one member selected from silica, alumina, zirconia, zirconium silicate, aluminum titanate, mullite, cordierite, eucryptite, spodumene, a zirconium phosphate compound, a quartz solid solution, soda lime glass and borosilicate glass. The zirconium phosphate compound may be (ZrO)₂P₂O₇, NaZr₂(PO₄)₃, KZr₂(PO₄)₃, Ca_{0.5}Zr₂(PO₄)₃, NbZr(PO₄)₃, Zr₂(WO₃)(PO₄)₂ or a composite compound thereof. The low-expansion filler is one having a lower thermal expansion coefficient than the sealing glass.

The content of the low-expansion filler is preferably set so that the thermal expansion coefficient of the sealing glass will be close to the thermal expansion coefficients of the glass substrates 1 and 2. The low-expansion filler is contained preferably in an amount of from 0.1 to 50 vol % to the sealing material, although it depends on the thermal expansion coefficients of the sealing glass and the glass substrates 1 and 2. The content of the low-expansion filler may suitably be changed also depending upon the thickness, etc. of the sealing material layer 7. However, if the content of the low-expansion filler exceeds 50 vol %, the fluidity at the time of melting the sealing material tends to deteriorate, whereby the adhesion with the first glass substrate 1 is likely to decrease. The content is preferably at most 45 vol %. The content of the low-expansion filler is influential as the total amount with the laser absorbent, and therefore, their total amount is preferably made to be within a range of from 0.1 to 50 vol %.

The sealing material layer 7 is formed as follows. Forming the sealing material layer 7 will be described with reference to FIGS. 6A-C. FIGS. 6A-C illustrate embodiments of the process for producing a glass member provided with a sealing material layer of the present invention. First, a laser absorbent, a low expansion filler and the like are blended with a sealing glass to prepare a sealing material, which is then mixed with a vehicle to prepare a sealing material paste.

The vehicle is one having a resin such as binder component dissolved in a solvent. As the resin for the vehicle, for example, a cellulose resin such as methyl cellulose, ethyl cellulose, carboxymethyl cellulose, oxyethyl cellulose, benzyl cellulose, propyl cellulose or nitro cellulose; or an organic resin such as an acrylic obtainable by polymerizing at least one acrylic monomer such as methyl methacrylate, ethyl methacrylate, butyl methacrylate or 2-hydroxyethyl methacrylate, butyl acrylate or 2-hydroxyethyl acrylate, may, for example, be used. As the solvent, in the case of a cellulose type resin, a solvent such as terpineol, butyl carbitol acetate or ethyl carbitol acetate, may be used, and in the case of an acrylic resin, a solvent such as methyl ethyl ketone, terpineol, butyl carbitol acetate or ethyl carbitol acetate may be used.

The resin component in the vehicle functions as an organic binder in the sealing material and is required to be burnt out before the sealing material is fired. The viscosity of the sealing material paste is fitted to the viscosity in accordance with an apparatus which applies the paste to the glass substrate 2, and may be adjusted by the ratio of the resin component as an organic binder to the organic solvent or the like or the ratio of the sealing material to the vehicle. To the sealing material paste, known additives for a glass paste, such as an antifoaming agent or a dispersing agent may be added. For preparation of the sealing material paste, a known method employing a rotary mixer equipped with a stirring blade, a roll mill, a ball mill or the like may be applied.

As shown in FIG. 6A, the sealing material paste is applied to the sealing region 6 along the peripheral portion of the second glass substrate 2 in a frame-form over the entire or substantially entire peripheral portion and dried to form a frame-form coating layer 8 (the frame-form coating layer may hereinafter referred to simply as a coating layer). The sealing material paste is applied to the second sealing region 6 employing, for example, a printing method such as screen printing or gravure printing, or applied along the second sealing region 6 using a dispenser or the like. The coating layer 8 is preferably dried, for example, at a temperature of at least 120° C. for at least 10 minutes. The drying step is carried out to remove the solvent in the coating layer 8. If the solvent remains in the coating layer 8, the organic binder may not sufficiently be burnt out in the following firing step (laser firing step).

Then, as shown in FIG. 6B, the frame-form coating layer (dried layer) 8 of the sealing material paste is irradiated with a laser light 9 for firing. By irradiating the coating layer 8 with the laser light 9 along it to selectively heat it, the sealing material is fired while the organic binder in the coating layer 8 is burnt out to form a sealing material layer 7 (FIG. 6C). The laser light 9 for firing is not particularly limited, and a desired laser light selected from e.g. a semiconductor laser, a carbon dioxide laser, an excimer laser, a YAG laser and a HeNe laser may be employed. The same applies to the after-mentioned laser light for sealing.

Firing the coating layer 8 with laser light 9 is particularly effective for a coating layer 8 having such a thickness that the thickness of the coating layer after firing (i.e. the thickness of the sealing material layer 7) will be at most 20 μm, although it is not necessarily limited to such a thickness of the coating layer 8. In a case where the thickness after firing exceeds 20 μm, it may not sometimes be possible to uniformly heat the entire coating layer with laser light 9. However, by adjusting the conditions for forming the coating layer 8 or the conditions of irradiation with laser light 9, it is possible to carry out firing with laser light 9 so long as the coating layer 8 is one having such a thickness that the thickness after the firing will be at most 150 μm. Practically, the thickness of the sealing material layer 7 is preferably adjusted to be at most 1 μm.

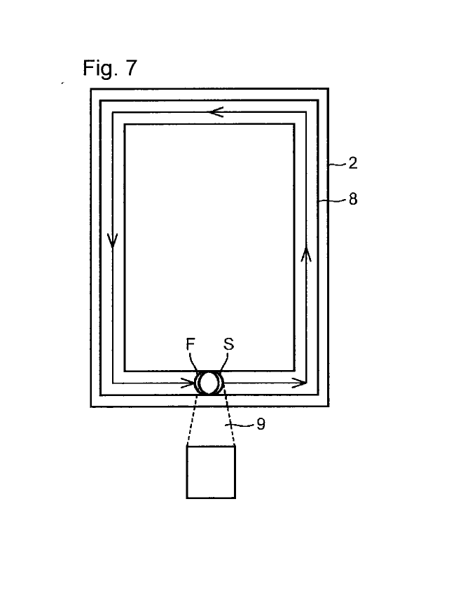

To form a sealing material layer 7 with laser light 9 for firing, first, as shown in FIG. 7, an irradiation starting position S of the frame-form coating layer 8 of the sealing material paste is irradiated with laser light 9. Then, while scanning along the frame-form coating layer 8 with laser light 9, irradiation is carried out. And, after heating the entire frame-form coating layer 8 by scanning with laser light 9 till an irradiation finishing position F which at least partially overlaps with the irradiation starting position S, the irradiation with laser light 9 is terminated. At the time of irradiation while scanning along the frame-form coating layer 8 with laser light 9, the heating temperature of the frame-form coating layer 8 is preferably adjusted to be within a range of at least (T+80° C.) and at most (T+550° C.) relative to the softening point T (° C.) of the sealing glass. Here, the softening temperature T of the sealing glass is a temperature at which the sealing glass is softened and flows but is not crystallized. Further, the temperature of the frame-form coating layer 8 when irradiated with laser light 9 is a value measured by a radiation thermometer.

When the frame-form coating layer 8 is irradiated with the laser light 9 so that the temperature of the coating layer 8 is within a range of at least (T+80° C.) and at most (T+550° C.), the sealing glass in the sealing material is melted whereby the sealing material is baked to the second glass substrate 2 to form the sealing material layer 7. Under conditions of irradiation with the laser light 9 such that the temperature of the frame-form coating layer 8 does not reach (T+80° C.), only the surface portion of the frame-form coating layer 8 is melted, and the entire frame-form coating layer 8 may not uniformly be melted. On the other hand, under conditions of irradiation with the laser light 9 such that the temperature of the frame-form coating layer 8 exceeds (T+550° C.), cracking, breakage, etc. are likely to form in the glass substrate 2 and the sealing material layer (fired layer) 7.

By scanning and irradiating the frame-form coating layer 8 with the laser light 9 so that the temperature of the frame-form coating layer (dried film) 8 becomes within the above-described range, the organic binder in the frame-form coating layer 8 is thermally decomposed and burnt out. Since the frame-form coating layer 8 is irradiated with the laser light 9 along it with scanning, a portion located ahead in the moving direction of the laser light 9 is properly pre-heated. Thermal decomposition of the organic binder proceeds by the pre-heated portion located ahead in the moving direction of the laser light 9 in addition to when the corresponding portion of the frame-form coating layer 8 is directly irradiated with the laser light 9, whereby the organic binder in the frame-form coating layer 8 can effectively and efficiently be burnt out. Specifically, the remaining carbon amount in the sealing material layer 7 can be reduced. The remaining carbon may increase the impurity gas concentration in the glass panel formed by sealing the first and second glass substrates along their peripheral portions.

The laser light 9 is preferably applied while scanning along the frame-form coating layer 8 at a scanning speed within a range of from 3 to 20 mm/sec. If the scanning speed with the laser light 9 at the time of scanning along the frame-form coating layer 8 is less than 3 mm/sec, the firing speed of the frame-form coating layer 8 with the laser light 9 decreases, whereby it becomes difficult to efficiently form the sealing material layer 7. On the other hand, if the scanning speed with the laser light 9 exceeds 20 mm/sec, only the surface portion is likely to be melted and vitrified before the entire frame-form coating layer 8 is uniformly heated, whereby discharge of a gas formed by thermal decomposition of the organic binder to the outside will be low. Accordingly, air bubbles may form in the interior of the sealing material layer 7, or deformation due to the air bubbles is likely to form on the surface. The carbon amount remaining in the sealing material layer 7 is also likely to increase. If a space between the glass substrates 1 and 2 is sealed by using a sealing material layer 7 from which the organic binder is poorly burnt out, the bond strength between the sealing layer and the glass substrates 1 and 2 may be decreased, or the airtightness of the glass panel may be decreased.

At the time of applying the laser light 9 while scanning along the frame-form coating layer 8 formed on the glass substrate at a predetermined scanning speed, the scanning may be carried out by moving the laser light source to emit the laser light relative to the glass substrate, or the scanning may be carried out by moving the glass substrate relative to the laser light source to emit the laser light. Otherwise, the scanning may be carried out by moving both of them.

The scanning speed with the laser light 9 is further preferably adjusted depending upon the thickness of the frame-form coating layer 8. For example, in the case of a frame-form coating layer 8 whereby the thickness after firing will be less than μm, the scanning speed of the laser light 9 may be made as high as at least 15 mm/sec. On the other hand, in the case of a frame-form coating layer 8 whereby the thickness after firing will exceed 20 μm, the scanning speed of the laser light 9 is preferably adjusted to be at most 5 mm/sec. The scanning speed of the laser light 9 at the time of firing a frame-form coating layer 8 whereby the thickness after firing will be within a range of from 5 to 20 μm, is preferably adjusted to be within a range of from 5 to 15 mm/sec.

Further, when the laser light 9 is applied at a scanning speed within a range of from 3 to 20 mm/sec and the heating temperature of the frame-form coating layer 8 is adjusted to be within a range of at least (T+80° C.) and at most (T+550° C.), the laser light 9 preferably has a power density within a range of from 100 to 1,100 W/cm². If the power density of the laser light 9 is less than 100 W/cm², the entire frame-form coating layer 8 may not uniformly be heated. If the power density of the laser light 9 exceeds 1,100 W/cm², the glass substrate 2 may excessively be heated, whereby cracking, breakage, etc. are likely to form.

Further, FIGS. 6A-C illustrate states of applying the laser light 9 from above the frame-form coating layer 8 formed on the second glass substrate. However, the laser light 9 may be applied to the frame-form coating layer 8 via the second glass substrate 2 i.e. from the side opposite to the side on which the frame-form coating layer 8 of the second glass substrate 2 is formed. For example, in order to shorten the firing time of the frame-form coating layer 8, a high power of the laser light 9 or a high scanning speed is effective. For example, if the high power laser light 9 is applied from above the frame-form coating layer 8, only the surface portion of the frame-form coating layer 8 is likely to be vitrified. Vitrification of only the surface portion of the frame-form coating layer 8 brings about the above-described various problems. Whereas, when the laser light 9 is applied to the frame-form coating layer 8 from the side opposite to the frame-form coating layer 8 of the second glass substrate 2 even if vitrification starts from the portion irradiated with the laser light 9, a gas formed by thermal decomposition of the organic binder can be released from the surface of the frame-form coating layer 8. It is also effective to apply the laser light 9 from both above and below the frame-form coating layer 8, i.e. from the side of the frame-form coating layer 8 formed on the second glass substrate and from the opposite side of the frame-form coating layer 8 of the second glass substrate 2.

The beam shape of the laser light 9 (i.e. the shape of the irradiation spot) is not particularly limited. The beam shape of the laser light 9 is commonly circular, but is not limited to circular. The beam shape of the laser light 9 may be elliptic with the width direction of the coating layer 8 being a minor axis. According to the laser light 9 adjusted to achieve an elliptic beam shape, the area of irradiation with the laser light 9 relative to the frame-form coating layer 8 can be broadened, and further, the scanning speed of the laser light 9 can be increased, whereby the firing time of the frame-form coating layer 8 can be shortened.

In forming the sealing material layer 7 according to this embodiment, the frame-form coating layer 8 of the sealing material paste is selectively heated by applying the laser light 9 for firing to the frame-form coating layer portion at the peripheral portion of the second glass substrate. Accordingly, even in a case where an organic resin film such as a color filter, an element film or the like is formed on the surface 2a of the second glass substrate 2, the sealing material layer 7 can be properly formed without imparting thermal damage to the organic resin film, the element film or the like. Further, as excellent removability of the organic binder is achieved, the sealing material layer 7 excellent in the sealing property, the reliability and the like can be obtained.

Further, of course, forming the sealing material layer 7 by the laser light 9 for firing is applicable to a case where no organic resin film, element film or the like is formed on the surface 2a of the second glass substrate 2, and in such a case also, the sealing material layer 7 excellent in the sealing property, the reliability and the like can be obtained. Further, in the firing step by the laser light 9, the energy consumption is low as compared with a firing step by a conventional heating furnace, and such contributes to the reduction in the production steps and the production cost. Accordingly, forming the sealing material layer 7 by the laser light 9 is effective also from the viewpoint of the energy saving, the cost reduction, etc.

By the way, in a case where irradiation is carried out while scanning with the laser light 9 along the frame-form coating layer 8 of the sealing material paste, in order to heat the entire frame-form coating layer 8, it is necessary to set so that the irradiation starting position S and the irradiation finishing position F with the laser light 9 in the frame-form coating layer 8 at least partially overlap with each other. During scanning with the laser light 9, the irradiation starting position S where melting of the sealing glass has already been completed, may be cooled and solidified. In such a case, at the time when the laser light 9 reaches the irradiation finishing position F which at least partially overlaps with the irradiation starting position S, the sealing glass may undergo shrinkage due to the surface tension, reduction of voids, etc. thereby to form a gap. If the gap formed in the sealing material layer 7 is wide, the hermetical sealing property of a glass package is likely to be low in the subsequent laser sealing step.

That is, it is considered that the surface tension becomes superior to the fluidity of the sealing glass heated and melted with the laser light 9, whereby the sealing glass undergoes shrinkage at the irradiation finishing position F to form a gap. With respect to such a point, it is effective to maintain the fluidized state of the sealing glass at the termination of irradiation with the laser light 9. By maintaining the molten state of the sealing glass at the time when the laser light 9 reaches the irradiation finishing position F, thereby to prolong the time of contact of the molten state sealing glass with the solidified sealing glass i.e. in other words, by letting the molten state sealing glass flow on the solidified sealing glass, it is possible to prevent formation of a gap caused by e.g. the surface tension of the sealing glass.

Specifically, in a case where the irradiation finishing position F with the laser light 9 in the frame-form coating layer 8 is set at a position which at least partially overlaps with the already fired portion of the frame-form coating layer 8 (i.e. the portion already melted and solidified by irradiation with the laser light 9), the scanning speed of the laser light 9 in a finishing region from a position close to the irradiation finishing position F to the irradiation finishing position F, is adjusted to be slower than the scanning speed of the laser light 9 in a scanning region along the frame-form coating layer 8 excluding the finishing region. By thus reducing the scanning speed of the laser light 9 in the finishing region, it becomes possible to let the molten state sealing glass flow towards the already solidified sealing glass and to let the molten state sealing glass be sufficiently in contact with the solidified state sealing glass. Thus, it becomes possible to narrow the width of the gap formed by the shrinkage due to deficiency of the fluidity of the sealing glass at the irradiation finishing position F.

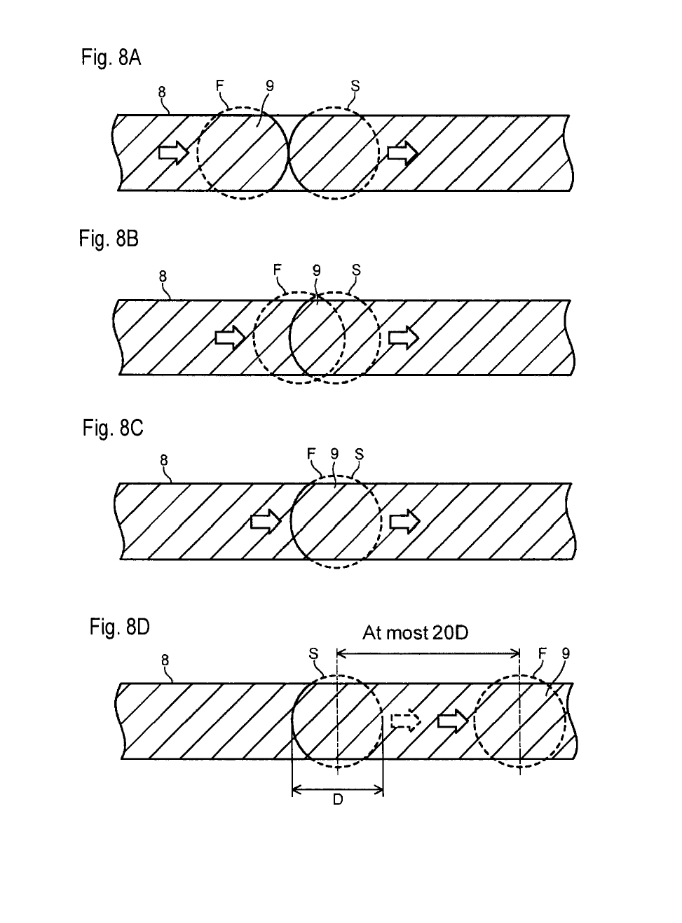

In the frame-form coating layer 8, the irradiation finishing position F with the laser light 9 is set at a position which at least partially overlaps with the already fired portion of the frame-form coating layer 8 (i.e. basically the position corresponding to the irradiation starting position S). It is thereby possible to integrate the sealing glass in a fluidized state. As shown in FIG. 8B, the irradiation finishing position F of the laser light 9 is preferably set at a position where the overlapping amount (the area ratio) with the irradiation starting position S becomes at least 50%. Further, the irradiation finishing position F of the laser light 9 is more preferably set at a position which overlaps with the irradiation starting position S as shown in FIG. 8C, or at a position beyond the irradiation starting position S as shown in FIG. 8D. It is thereby possible to more excellently let the molten state sealing glass be in contact with the fired portion of the frame-form coating layer 8 (i.e. the solidified state sealing glass) in the finishing region.

In a case where the irradiation finishing position F of the laser light 9 is set at a position beyond the irradiation starting position S as shown in FIG. 8D, the length of the region irradiated overlappingly with the laser light 9 is not particularly limited. However, even if the overlapping irradiation region with the laser light 9 is prolonged too much, it is not only impossible to further increase the effect to improve the contact between the molten state sealing glass and the solidified state sealing glass, but also the time for forming the sealing material layer 7 is prolonged correspondingly to deteriorate the forming efficiency. Therefore, the overlapping irradiation region with the laser light 9 is preferably made to be a distance of at most 20 times the beam diameter D of the laser light 9 from the center of the irradiation starting position S, based on the beam center of the laser light 9, particularly preferably a distance of at most 5 times the beam diameter D of the laser light 9. Here, the beam shape of the laser light 9 is defined by a region where the intensity becomes 1/e² of the beam maximum intensity.

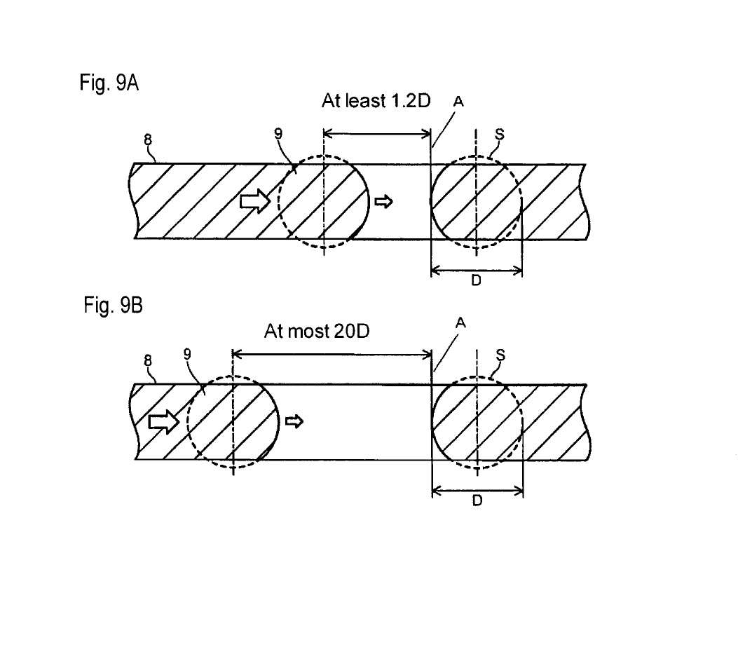

As shown in FIG. 9A, the position where the speed of the laser light 9 is reduced (i.e. the starting position of the finishing region) is preferably set to be a position distant by at least 1.2 times the beam diameter of the laser light 9 from the fired end A of the fired portion of the frame-form coating layer 8, based on the beam center of the laser light 9. If the speed is reduced from a position less than 1.2 times the beam diameter D of the laser light 9, the contact time between the molten state sealing glass and the solidified state sealing glass in the finishing region is likely to be inadequate. The speed-reduction-starting position of the laser light 9 may be at a position distant by at least 1.2 times the beam diameter D of the laser light 9 from the fired end A of the frame-form coating layer 8, and the speed may be reduced from a position more distant than the position at 1.2 times of the beam diameter D (i.e. a position more distant from the fired end A).

However, if the speed is reduced from a position distant too much from the fired end A of the frame-form coating layer 8, the scanning time with the laser light 9 in the reduced speed state increases correspondingly, and the time for forming the sealing material layer 7 is prolonged correspondingly, whereby the forming efficiency decreases. Therefore, the speed reduction-starting position of the laser light 9 is preferably set to be a position distant by at most 20 times the beam diameter D of the laser light 9 from the fired end A of the frame-form coating layer 8, based on the beam center of the laser light 9, as shown in FIG. 9B. Thus, the speed reduction-starting position of the laser light 9 is preferably set within a range distant by at least 1.2 times and at most 20 times the beam diameter D of the laser light 9 from the fired end A of the frame-form coating layer 8, and particularly preferably set within a range distant by at least 1.2 times and at most 5 times the beam diameter D from the fired end A.

As mentioned above, the scanning speed of the laser light 9 at the time of scanning along the frame-form coating layer 8 (i.e. the scanning speed of the laser light 9 in the scanning region) is preferably adjusted to be within a range of from 3 to 20 mm/sec. Relative to such a scanning speed of the laser light 9 in the scanning region, it is preferred to reduce the scanning speed of the laser light 9 to 2 mm/sec in the finishing region. It is thereby possible to well contact the molten state sealing glass with the fired portion of the frame-form coating layer 8 (i.e. the solidified state sealing glass) in the finishing region. The scanning speed of the laser light 9 in the finishing region is more preferably reduced to at most 0.5 mm/sec. The lower limit value for the scanning speed of the laser light 9 in the finishing region is not particularly limited, but in consideration of e.g. the excessive heating of the glass substrate 2, a decrease in the forming efficiency of the sealing material layer 7, etc., it is preferably set to be at least 0.1 mm/sec (for example, based on the position distant by 1.2 times of the beam diameter).

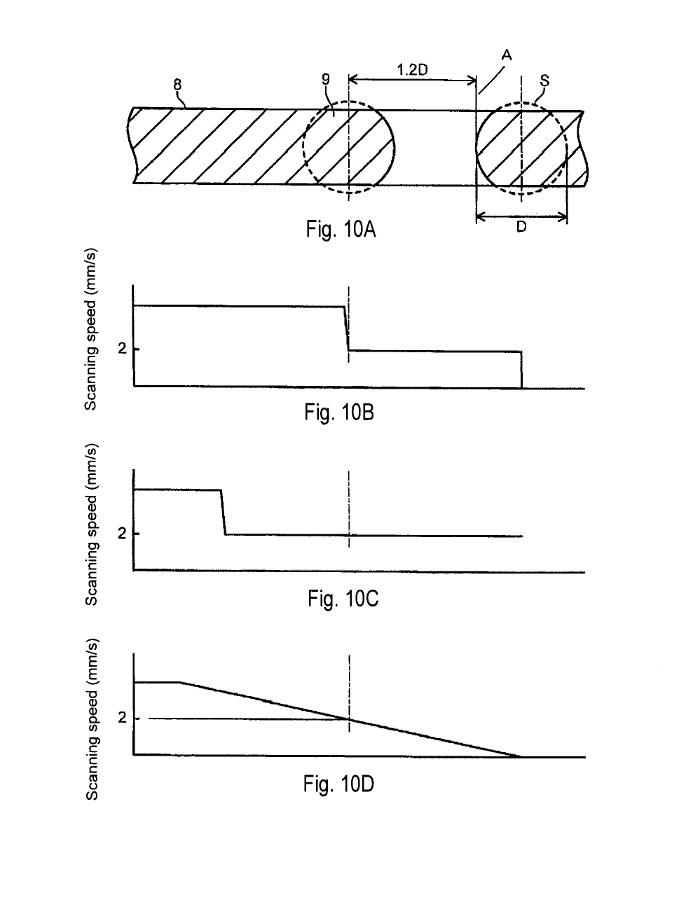

As shown in FIGS. 10A and 10B, the scanning speed of the laser light 9 in the finishing region is preferably adjusted to be at most 2 mm/sec at a position distant by 1.2 times the beam diameter D of the laser light 9 from the fired end A of the fired portion of the frame-form coating layer 8, based on the beam center of the laser light 9. The speed reduction-starting position of the laser light 9 may be at a position distant by at least 1.2 times the beam diameter D of the laser light 9 from the fired end A of the frame-form coating layer 8 as mentioned above, and therefore, as shown in FIG. 10C, scanning with the laser light 9 at a speed of at most 2 mm/sec may be started from a position more distant from the fired end A than the position distant by 1.2 times the beam diameter D of the laser light 9, i.e. from a position within a range of at least 1.2 times and at most 20 times the beam diameter D of the laser light 9.

FIGS. 10B and 10C illustrate a state of scanning with the laser light 9 in the finishing region at a constant speed lower than the scanning speed in the scanning region, e.g. at a constant speed of at most 2 mm/sec. The reduced speed state of the laser light 9 in the finishing region is not limited to such an example. As shown in FIG. 10D, the scanning speed with the laser light 9 may be reduced at a predetermined reducing rate from the speed reduction starting position of the laser light 9 (within a range of at least 1.2 times and at most 20 times the beam diameter D) to the irradiation finishing position F. Also in such a case, the scanning speed is preferably adjusted to be at most 2 mm/sec at the time when the beam center of the laser light 9 has reached a position distant by 1.2 times the beam diameter D of the laser light 9 from the fired end A of the frame-form coating layer 8. In any case, it is preferred to adjust the scanning speed with the laser light 9 to be at most 2 mm/sec at a position distant by 1.2 times the beam diameter D of the laser light 9 from the fired end A, whereby it is possible to narrow the width of the gap to be formed at the irradiation finishing position F with good reproducibility.

As mentioned above, in the finishing region, the scanning speed of the laser light 9 is adjusted to be lower than the scanning speed of the laser light 9 in the scanning region, whereby there may be a case where the heating temperature of the frame-form coating layer 8 becomes too high at the same power density as the laser light 9 in the scanning region. In such a case, it is preferred to lower the power density of the laser light 9 in the finishing region than in the scanning region. Specifically, the power density of the laser light 9 in the finishing region is preferably adjusted to be within a range of from 100 to 700 W/cm². It is thereby possible to prevent excessive heating of the frame-form coating layer 8 thereby to prevent cracking, breakage, etc. of the glass substrate 2 or the sealing material layer 7 by such excessive heating. However, if the heating temperature of the frame-form coating layer 8 in the finishing region is within the above range, the laser light 9 may be applied under the same condition as in the scanning region.

The gap to be formed at the irradiation finishing position F can be suppressed by lowering the scanning speed of the laser light 9 in the finishing region than that in the scanning region. Further, the gap width in the irradiation finishing position F is influenced also by the fluidity of the sealing material. The fluidized state of the sealing material is influenced by e.g. the content, particle diameter, etc. of the laser absorbent or the low-expansion filler to be added to the sealing glass. Therefore, the fluidity-inhibitory factor of the sealing material as represented by the sum of the products of the contents (mass %) and the specific surface area (m²/g) of the laser absorbent and the low-expansion filler, is preferably made to be at most 300. It is further preferably at most 250. It is thereby possible to further narrow the gap width, since the fluidity of the sealing material is improved.

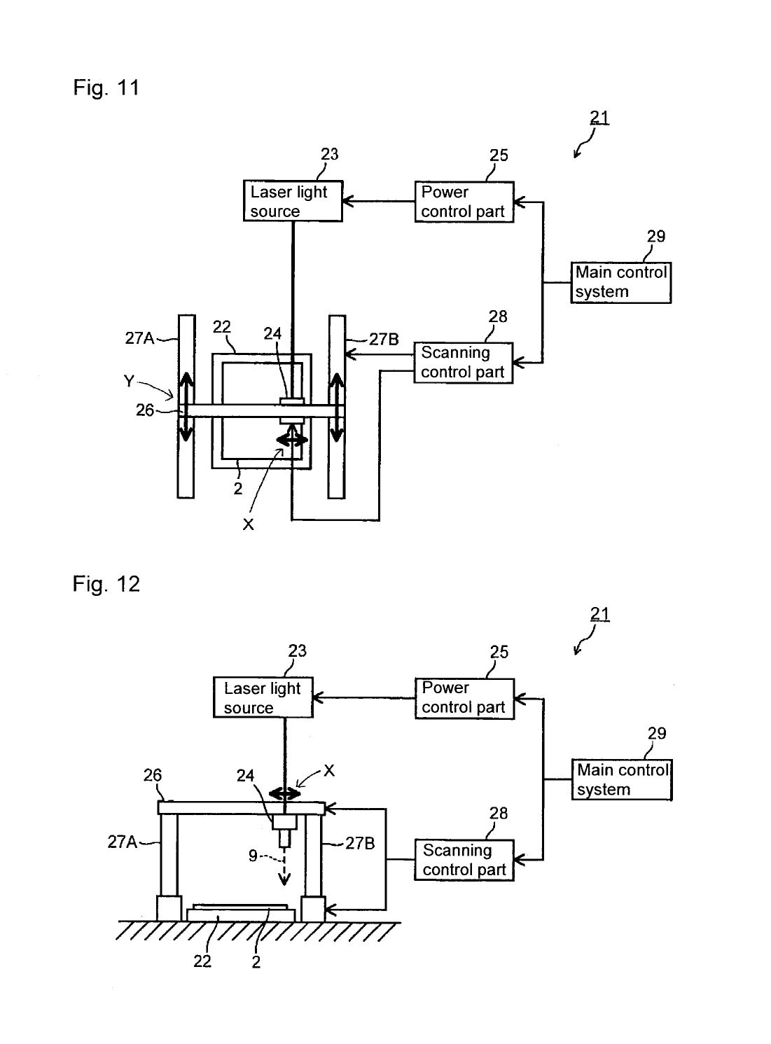

Now, a laser firing apparatus will be described in detail. In FIGS. 11 and 12, a laser firing apparatus according to one embodiment is shown. These Figs. show an apparatus for producing a glass member provided with a sealing material according to an embodiment of the present invention. A laser firing apparatus (i.e. an apparatus for producing a glass member provided with a sealing material layer) 21 comprises a sample table 22 on which a glass substrate 2 having a frame-form coating layer 8 of a sealing material paste is to be placed, a laser light source 23, and a laser irradiation head 24 to irradiate the frame-form coating layer 8 with a laser light emitted from the laser light source 23.

Although not shown in the drawings, the laser irradiation head 24 has an optical system which focuses a laser light emitted from the laser light source 23, shapes it into a predetermined beam shape and applies it to the frame-form coating layer 8. The optical system will be described later. The laser light emitted from the laser light source 23 is sent to the laser irradiation head 24. The power of the laser light is controlled by a power control part 25. The power control part 25 controls the power of the laser light, for example, by controlling an electric power to be input into the laser light source 23. Further, the power control part 25 may have a power modulator to control the power of the laser light emitted from the laser light source 23.

The laser light 9 emitted from the laser irradiation head 24 is applied while scanning from the irradiation starting position to the irradiation finishing position of the frame-form coating layer 8 of the sealing material paste. That is, the laser irradiation head 24 is made movable in an X-direction (i.e. in a horizontal direction in the plane of FIG. 12) by an X stage 26. The X stage 26 is made movable in a Y-direction by two Y stages 27A and 27B. The X stage 26 moves in a Y direction (i.e. in a vertical direction to the plane of FIG. 12) above the fixed sample table 22. The positional relation between the laser irradiation head 24 and the sample table 22 is made relatively movable by the X stage 26 and the Y stages 27A and 27B. The X stage 26 and the Y stages 27A and 27B constitute a moving mechanism. The moving mechanism may be constituted by an X stage 26 to move the laser irradiation head 24 in the X-direction and a Y stage to move the sample table 22 in the Y-direction.

The X stage 26 and the Y stages 27A and 27B are controlled by a scanning control part 28. The scanning control part 28 controls the X stage 26 and the Y stages 27A and 27B (the moving mechanism) so as to apply the laser light 9 while scanning along the frame-form coating layer 8 from the irradiation starting position to the irradiation finishing position. The laser firing apparatus 21 is provided with a main control system 29 which comprehensively controls the power control part 25 and the scanning control part 28. Further, the laser firing apparatus 21 is provided with a radiation thermometer (not shown) for measuring the firing temperature (the heating temperature) of the frame-form coating layer 8. The laser firing apparatus 21 is preferably provided with an activation nozzle, a blast nozzle or the like to prevent deposition of an organic binder removed from the frame-form coating layer 8, on the optical system or glass substrate 2.

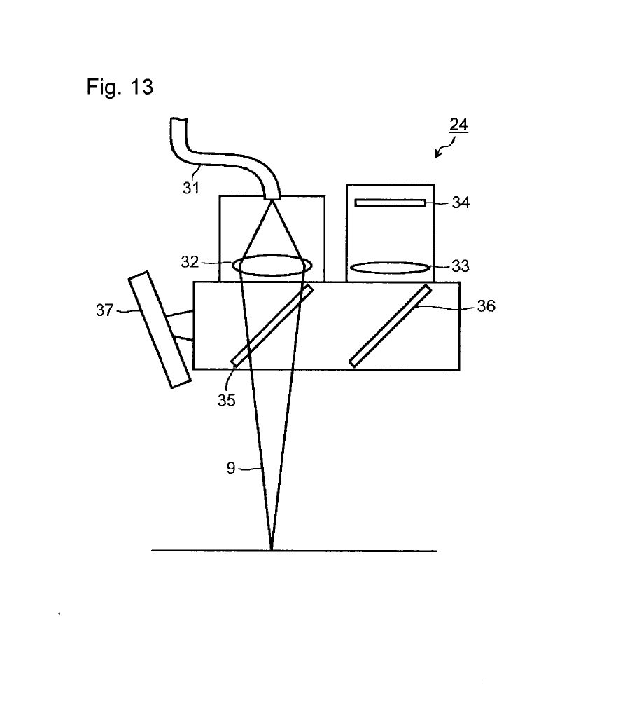

The laser irradiation head 24 comprises, for example, as shown in FIG. 13, an optical fiber 31 which transmits the laser light emitted from the laser light source 23, a condenser lens 32 which focuses the laser light and shapes it into a desired beam shape, an imaging lens 33 and CCD imaging element 34 to observe the portion irradiated with the laser light 9, and a dichromic mirror 35 and a reflecting mirror 36 which reflect light other than the laser light from the portion irradiated with the laser light 9 (the laser light is transmitted) and guide it to the CCD imaging element 34. An irradiation thermometer 37 which measures the temperature of the portion irradiated with the laser light 9, is installed.

An example of scanning with the laser light 9 by means of the laser firing apparatus 21 will be described with reference to FIG. 7. First, the laser light 9 is applied to an irradiation starting position S of the frame-form coating layer 8. Scanning with the laser light 9 is carried out along the frame-form coating layer 8 from the irradiation starting position S to the irradiation finishing position F. The scanning with the laser light 9 is controlled by the scanning control part 28 so that the scanning speed in the finishing region becomes slower than the scanning speed in the scanning region. The specific scanning conditions with the laser light 9 in the finishing region are as mentioned above. By irradiating the frame-form coating layer 8 with the laser light 9 under such scanning conditions, it is possible to narrow the width of the gap in the irradiation finishing position F, and further it is possible to prevent formation of a gap.

The laser light is not limited to one, and plural laser lights may be used. That is, a plurality of laser irradiation heads may be prepared which can be independently operated for scanning, and a plurality of laser lights from such a plurality of laser irradiation heads, are applied, respectively, to the frame-form coating layer of the sealing material paste, whereby the firing time of the frame-form coating layer can be shortened. In a case where a plurality of laser lights are to be used, the respective irradiation starting positions are set not to overlap one another, and scanning is carried out so that the scanning direction is in the same rotation direction along the frame-form coating layer. Further, the irradiation finishing positions of the respective laser lights are set to overlap with the initiation starting positions of other laser lights appearing first in the traveling direction of the laser lights.

Now, the process for producing an electronic device of the present invention will be described.

As shown in FIG. 1B, a first glass substrate 1 and a second glass substrate 2 having a sealing material layer formed along its peripheral portion are laminated via the sealing material layer 7 so that surfaces 1a and 2a face each other. Thereafter, as shown in FIG. 1C, sealing laser light 10 is applied to the sealing material layer 7 through the second glass substrate 2 from above the second glass substrate 2 of the laminated glass assembly. The sealing laser light 10 may be applied to the sealing material layer 7 through the first glass substrate 1 from below the first glass substrate 1 on the side opposite to the second glass substrate of the laminated glass assembly. Otherwise, the sealing laser light may be applied from both sides i.e. from above the second glass substrate 2 of the laminated glass assembly and from below the first glass substrate 1 on the side opposite to the second glass substrate of the laminated glass assembly. The sealing laser light 10 is applied while scanning along the frame-form sealing material layer 7. The sealing material layer 7 is sequentially melted from a portion irradiated with the laser light 10, and is quenched and solidified upon completion of irradiation with the laser light 10 and bonded to the first glass substrate 1. And, by applying the sealing laser light 10 over the entire perimeter of the sealing material layer 7, a sealing layer 11 to seal a space between the first glass substrate 1 and the second glass substrate 2 is formed as shown in FIG. 1D.

In such a manner, an electronic device 12 having an electronic element portion 4 disposed between the first glass substrate 1 and the second glass substrate 2 hermetically sealed in a glass package comprising the first glass substrate 1, the second glass substrate 2 and the sealing layer 11 and having its peripheral portion sealed, is prepared. Here, the glass package in this embodiment is not limited to a member constituting the electronic device 12, and is applicable to a sealed product of electronic component, or a glass member for e.g. a building material such as double-glazed glass.

According to the process for production of the electronic device 12 in this embodiment, even in a case where an organic resin film, an element film or the like is formed on the surface 2a of the second glass substrate 2, the sealing material layer 7 and the sealing layer 11 can be formed well without imparting thermal damage to such a film. Accordingly, an electronic device 12 excellent in the airtightness and the reliability can be prepared with good reproducibility without impairing the function and the reliability of the electronic device 12.

### EXAMPLES

Now, the present invention will be described in detail with reference to specific Examples and the evaluation results. However, it should be understood that the present invention is by no means restricted to the following specific Examples, and modification within the scope of the present invention is possible.

### Example 1

Bismuth glass frit (softening temperature: 410° C.) having a composition comprising 83 mass % of Bi₂O₃, 5 mass % of B₂O₃, 11 mass % of ZnO and 1 mass % of Al₂O₃ and having an average particle size of 1 μm, a cordierite powder having an average particle size of 0.9 μm and a specific surface area of 12.4 m²/g as a low-expansion filler, and a laser absorbent having a composition of Fe₂O₃—Al₂O₃—MnO—CuO and having an average particle size of 0.8 μm and a specific surface area of 8.3 m²/g, were prepared. Here, the average particle size was measured by a laser diffraction particle size distribution measuring apparatus (tradename: SALD2100) manufactured by Shimadzu Corporation using a laser diffraction/scattering method. The same applies to the following Examples.

The specific surface areas of the cordierite powder and the laser absorbent powder were measured by using an BET specific surface area measuring apparatus (device name: Macsorb HM model-1201, manufactured by MOUNTEC CO., LTD.). The measurement conditions were such that the adsorbent was nitrogen, the carrier gas was helium, the measuring method was a floating method (BET 1 point type), the evacuation temperature was 200° C., the evacuation time was 20 minutes, the evacuation pressure was N₂ gas flow-atmospheric pressure, and the sample weight was 1 g. The same applies to the following Examples.

66.9 vol % (79.8 mass %) of the bismuth glass frit, 19.2 vol % (8.8 mass %) of the cordierite powder and 13.9 vol % (11.4 mass %) of the laser absorbent were mixed to prepare a sealing material. 80 mass % of the sealing material was mixed with 20 mass % of a vehicle to prepare a sealing material paste. The vehicle is one having ethyl cellulose (2.5 mass %) as a binder component dissolved in a solvent (97.5 mass %) comprising terpineol. The sum of products of the contents (mass %) and the specific surface areas (m²/g) of the cordierite and the laser absorbent powder (the fluidity-inhibitory factor of the sealing material) was 203.7.

Then, a second glass substrate (dimension: 90×90×0.7 mm) made of alkali-free glass (thermal expansion coefficient: 38×10⁻⁷/K) was prepared, and the sealing material paste was applied to a sealing region along the entire peripheral portion of this glass substrate in a frame-shape (i.e. frame-form) by a screen printing method and dried at 120° C. for 10 minutes to form a frame-form coating layer. The sealing material paste was applied so that the thickness would be 14 μm after drying. On the surface of the second glass substrate, a color filter made of a resin was formed, and it is necessary to form a sealing layer on the sealing region of the second glass substrate without imparting thermal damage to the color filter.

Then, the alkali-free glass substrate having the frame-form coating layer of the sealing material paste formed thereon was disposed on a sample holder of a laser irradiation apparatus by means of an alumina substrate having a thickness of 0.5 mm. A laser light having a wavelength of 940 nm and a power density of 708 W/cm² and having a circular beam shape with a diameter of 1.5 mm, was applied along the frame-form coating layer of the sealing material paste on the glass substrate. The scanning speed with the laser light was adjusted to be 5 mm/sec. The heating temperature of the frame-form coating layer at that time was 760° C. At the time when the laser light reached a position distant by 5 mm from the fired end of the frame-form coating layer, the scanning speed was reduced to 0.5 mm/sec, and at the same time, the laser power was reduced so that the power density became 396 W/cm². The laser light under such conditions was applied to the irradiation finishing position. The heating temperature of the frame-form coating layer at the time of the reduced speed was 760° C. The irradiation finishing position with the laser light was set at a position 5 mm beyond the fired end (the already fired portion) of the frame-form coating layer. In such a manner, the entire frame-form coating layer of the sealing material paste was fired by the laser light to form a sealing material layer having a thickness of 8.5 μm.

The state of the obtained sealing material layer was observed by SEM, whereby it was confirmed that the entire sealing material layer was well vitrified. In the sealing material layer, no formation of the surface deformation or air bubbles attributable to an organic binder was observed. Further, it was attempted to measure the width of a gap at the irradiation finishing position by a length-measuring microscope (laser microscope: VK-8500, manufactured by KEYENCE CORPORATION), whereby it was confirmed that no gap was formed at the irradiation finishing position with the laser light (gap width=0 μm). The residual carbon amount in the sealing material layer was measured, whereby it was confirmed to be equal to the residual carbon amount when a coating layer of the same sealing material paste was fired in an electric furnace (at 300° C. for 40 minutes). Further, it was confirmed that no thermal damage or the like was imparted to the color filter formed on the surface of the glass substrate.

Then, the above second glass substrate having the sealing material layer and a first glass substrate (a substrate made of alkali-free glass having the same composition and the same shape as the second glass substrate) having an element region were laminated to obtain a glass assembly having the first glass substrate and the second glass substrate laminated. Then, from outside of the second glass substrate of the glass assembly, the laser light was applied through the second glass substrate while scanning along the sealing material layer, to melt the sealing material layer and then to quench and solidify it to bond the first glass substrate and the second glass substrate. The obtained glass package was subjected to a high temperature high humidity test (temperature: 60° C., humidity: 90%) and a heat cycle test (−40° C. to 85° C.), whereby in the high temperature high humidity test, durability of at least 1,000 hours was observed, and in the heat cycle test, durability of at least 200 cycles was observed, and thus, the glass package was confirmed to have an excellent reliability. Further, the airtightness of the glass package subjected to the above reliability test was measured by a He leak test (vacuum method), whereby it was confirmed that the glass package had a very high airtightness of 1.0×10⁻¹⁰ (Pa·m³/s). Further, it was confirmed that the obtained glass package was excellent in the appearance, the bond strength, etc.

### Examples 2 to 10

A sealing material layer was formed by firing the frame-form coating layer with a laser light in the same manner as in Example 1 except that the particle shapes and the contents of the cordierite powder and the laser absorbent powder in the sealing material, the thickness of the frame-form coating layer, the scanning speeds in the scanning region and the finishing region with the laser light, the heating temperature of the frame-form coating layer, etc. were changed to the conditions as shown in Tables 1 and 2. The state of the sealing material layer was observed by SEM, whereby it was confirmed that the entire sealing material layer was well vitrified. The gap width at the irradiation finishing position was measured by a length-measuring microscope. The results are shown in Tables 1 and 2. In the same manner as in Example 1, the second glass substrate and the first glass substrate were laminated, and then the laser light was applied to the sealing material layer through the second glass substrate, to bond the first glass substrate and the second glass substrate. The obtained glass package was confirmed to be excellent in the reliability, the airtightness, the appearance, the bond strength, etc.

TABLE 1

| | | | | Ex. 1 | Ex. 2 | Ex. 3 | Ex. 4 | Ex. 5 |
|---|---|---|---|---|---|---|---|---|
| Sealing | Glass frit | Material | | Bismuth glass | | | | |
| material | | Content (vol %) | | 66.9 | 74.6 | 68.3 | 66.9 | 74.6 |
| | | Content (mass %) | | 79.8 | 84.0 | 82.7 | 79.8 | 79.8 |
| | Low- | Material | | Cordierite | | | | |
| | expansion | Particle | Average particle diameter (μm) | 0.9 | 0.9 | 1.8 | 0.9 | 0.9 |
| | filler | shape | Specific surface area (m²/g) | 12.4 | 12.4 | 4.3 | 12.4 | 12.4 |
| | | Content (vol %) | | 19.1 | 10.6 | 24.8 | 19.1 | 10.6 |
| | | Content (mass %) | | 8.8 | 4.6 | 11.6 | 8.8 | 4.6 |
| | Laser | Material | | Fe-Al-Mn-Cu-O | | | | |
| | absorbent | Particle | Average particle diameter | 0.8 | 0.8 | 1.2 | 0.8 | 0.8 |
| | | shape | (μm) | | | | | |
| | | | Specific surface area | 8.3 | 8.3 | 6.3 | 8.3 | 8.3 |
| | | | (m²/g) | | | | | |

| | | Content (vol %) | 13.9 | 14.8 | 6.9 | 13.9 | 14.8 |
|---|---|---|---|---|---|---|---|
| | | Content (mass %) | 11.4 | 11.4 | 5.7 | 11.4 | 11.4 |
| | Fluidity-inhibitory factor | | 203.7 | 151.7 | 85.8 | 203.7 | 151.7 |
| | Thermal expansion coefficient (×10⁻⁷/K) | | 80 | 90 | 72 | 80 | 90 |
| Dried thickness of frame-form coating layer (μm) | | | 14 | 14 | 14 | 6.4 | 6.4 |
| Laser firing | Scanning | Scanning speed (mm/sec) | 5 | 5 | 5 | 5 | 5 |
| conditions | region | Power density (W/cm²) | 708 | 708 | 764 | 679 | 793 |
| | | Firing temperature (° C.) | 760 | 840 | 780 | 740 | 800 |
| | Finishing | Scanning speed (mm/sec) | 0.5 | 0.5 | 0.5 | 0.5 | 0.5 |
| | region | Power density (W/cm²) | 396 | 425 | 425 | 425 | 453 |
| | | Firing temperature (° C.) | 760 | 840 | 780 | 740 | 800 |

| | | | | | | |
|---|---|---|---|---|---|---|
| Sealing | Thickness (μm) | 8.5 | 8.3 | 8.3 | 3.8 | 3.6 |
| material | Gap width (μm) | 0 | 0 | 0 | 0 | 0 |
| layer | | | | | | |

TABLE 2

| | | | | Ex. 6 | Ex. 7 | Ex. 8 | Ex. 9 | Ex. 10 |
|---|---|---|---|---|---|---|---|---|
| Sealing | Glass frit | Material | | Bismuth glass | | | | |
| material | | Content (vol %) | | 74.6 | 74.6 | 74.6 | 74.6 | 74.6 |
| | | Content (mass %) | | 84.0 | 84.0 | 84.0 | 84.0 | 84.0 |
| | Low- | Material | | Cordierite | | | | |
| | expansion | Particle | Average particle diameter (μm) | 0.9 | 0.9 | 0.9 | 0.9 | 0.9 |
| | filler | shape | Specific surface area (m²/g) | 12.4 | 12.4 | 12.4 | 12.4 | 12.4 |
| | | Content (vol %) | | 10.6 | 10.6 | 10.6 | 10.6 | 10.6 |
| | | Content (mass %) | | 4.6 | 4.6 | 4.6 | 4.6 | 4.6 |
| | Laser | Material | | Fe-Al-Mn-Cu-O | | | | |
| | absorbent | Particle | Average particle diameter | 0.8 | 0.8 | 0.8 | 0.8 | 0.8 |
| | | shape | (μm) | | | | | |
| | | | Specific surface area | 8.3 | 8.3 | 8.3 | 8.3 | 8.3 |
| | | | (m²/g) | | | | | |

| | | Content (vol %) | 14.8 | 14.8 | 14.8 | 14.8 | 14.8 |
|---|---|---|---|---|---|---|---|
| | | Content (mass %) | 11.4 | 11.4 | 11.4 | 11.4 | 11.4 |
| | Fluidity-inhibitory factor | | 151.7 | 151.7 | 151.7 | 151.7 | 151.7 |
| | Thermal expansion coefficient (×10⁻⁷/K) | | 90 | 90 | 90 | 90 | 90 |
| Dried thickness of frame-form coating layer (μm) | | | 6.4 | 6.4 | 6.4 | 6.4 | 6.4 |
| Laser firing | Scanning | Scanning speed (mm/sec) | 10 | 10 | 10 | 10 | 15 |
| conditions | region | Power density (W/cm²) | 906 | 906 | 906 | 906 | 940 |
| | | Firing temperature (° C.) | 800 | 800 | 800 | 800 | 800 |
| | Finishing | Scanning speed (mm/sec) | 0.1 | 0.5 | 1.0 | 3.0 | 0.5 |
| | region | Power density (W/cm²) | 238 | 453 | 538 | 651 | 453 |
| | | Firing temperature (° C.) | 800 | 800 | 800 | 800 | 800 |

| | | | | | | |
|---|---|---|---|---|---|---|
| Sealing | Thickness (μm) | 3.6 | 3.6 | 3.6 | 3.6 | 3.6 |
| material | Gap width (μm) | 30 | 60 | 65 | 250 | 60 |
| layer | | | | | | |

### Example 11

A bismuth glass frit, a cordierite powder and a laser absorbent powder having the same compositions and the same shapes as in Example 1 were prepared, and 74.4 vol % (85.0 mass %) of the bismuth glass frit, 14.9 vol % (6.6 mass %) of the cordierite powder and 10.7 vol % (8.4 mass %) of the laser absorbent were mixed to prepare a sealing material. 80 mass % of this sealing material was mixed with 20 mass % of a vehicle having the same composition as in Example 1 to prepare a sealing material paste. The sum of products of the contents (mass %) and the specific surface areas (m²/g) of the cordierite and the laser absorbent powder (the fluidity-inhibitory factor of the sealing material) was 145.

Then, a second glass substrate (dimension: 90×90×0.7 mm) made of alkali-free glass (thermal expansion coefficient: 38×10⁻⁷/K) was prepared, and the sealing material paste was applied to the sealing region of this glass substrate in a frame-shape by means of a dispenser and then dried under conditions of 120° C. for 10 minutes to form a frame-form coating layer. The sealing material paste was applied so that the thickness after drying would be 7 μm. On the surface of the second glass substrate, a color filter made of a resin was formed, and it is necessary to form a sealing layer on the sealing region of the second glass substrate without imparting thermal damage to the color filter.

Then, the alkali-free glass substrate having the frame-form coating layer of the sealing material paste formed thereon was disposed on a sample holder of a laser irradiation apparatus by means of an alumina substrate having a thickness of 0.5 mm. A laser light having a wavelength of 808 nm and a power density of 538 W/cm² and having a circular beam shape with a diameter of 1.5 mm, was applied along the frame-form coating layer of the sealing material paste on the glass substrate. The scanning speed with the laser light was adjusted to be 5 mm/sec. The heating temperature of the frame-form coating layer at that time was 625° C. At the time when the laser light reached a position distant by 3 mm from the fired end of the frame-form coating layer, the scanning speed was reduced to 0.5 mm/sec, and at the same time, the laser power was also reduced so that the power density became 283 W/cm². The laser light under such conditions was applied to the irradiation finishing position. The heating temperature of the frame-form coating layer at the time of the reduced speed was 600° C. The irradiation finishing position with the laser light was set at a position 3 mm beyond the fired end (the already fired portion) of the frame-form coating layer. In such a manner, the entire frame-form coating layer of the sealing material paste was fired by the laser light to form a sealing material layer having a thickness of 4.3 μm.

The state of the obtained sealing material layer was observed by SEM, whereby it was confirmed that the entire sealing material layer was well vitrified. In the sealing material layer, no formation of the surface deformation or air bubbles attributable to an organic binder was observed. Further, it was attempted to measure the width of a gap at the irradiation finishing position by a length-measuring microscope, whereby it was confirmed that no gap was formed at the irradiation finishing position with the laser light (gap width=0 μm). The residual carbon amount in the sealing material layer was measured, whereby it was confirmed to be equal to the residual carbon amount when the coating layer of the same sealing material paste was fired in an electric furnace (at 300° C. for 40 minutes). Further, it was confirmed that no thermal damage or the like was imparted to the color filter formed on the surface of the glass substrate.

Then, the above second glass substrate having the sealing material layer and a first glass substrate (a substrate made of alkali-free glass having the same composition and the same shape as the second glass substrate) having an element region were laminated. In the same manner as in Example 1, then, the laser light was applied through the second glass substrate while scanning along the sealing material layer to melt the sealing material layer and to quench and solidify it to bond the first glass substrate and the second glass substrate. The obtained glass package was subjected to a high temperature high humidity test (temperature: 60° C., humidity: 90%) and a heat cycle test (−40° C. to 85° C.), whereby in the high temperature high humidity test, durability of at least 1,000 hours was observed, and in the heat cycle test, durability of at least 200 cycles was observed, and thus it was confirmed that the glass package had an excellent reliability. Further, the airtightness of the glass package subjected to the above reliability test was measured by a He leak test (vacuum method), whereby it was confirmed that the glass package had a very high airtightness of 1.0×10⁻¹° (Pa·m³/s). Further, it was confirmed that the obtained glass package was excellent in the appearance, the bond strength, etc.

### Example 12

In the same manner as in Example 11, an alkali-free glass substrate having a frame-form coating layer of the sealing material paste formed thereon, was disposed on a sample holder of a laser irradiation apparatus by means of an alumina substrate having a thickness of 0.5 mm. A laser light having a wavelength of 808 nm and an power density of 368 W/cm² and having a circular beam shape with a diameter of 1.5 mm was applied along the frame-form coating layer of the sealing material paste on the glass substrate. The scanning speed with the laser light was adjusted to be 3 mm/sec. The heating temperature of the frame-form coating layer at that time was 560° C. At the time when the laser light reached a position distant by 3 mm from the fired end of the frame-form coating layer, the scanning speed was reduced to 0.5 mm/sec, and while maintaining the power density to be 368 W/cm², the laser light was applied to the irradiation finishing position. The heating temperature of the frame-form coating layer at the time of the speed reduction was 670° C. The irradiation finishing position with the laser light was set at a position 3 mm beyond the fired end (the already fired portion) of the frame-form coating layer. In such a manner, the entire frame-form coating layer of the sealing material paste was fired by the laser light to form a sealing material layer having a thickness of 4.3 μm.

The state of the obtained sealing material layer was observed by SEM, whereby it was confirmed that the entire sealing material layer was well vitrified. In the sealing material layer, no formation of the surface deformation or air bubbles attributable to an organic binder was observed. Further, it was attempted to measure the width of a gap at the irradiation finishing position by a length-measuring microscope, whereby it was confirmed that no gap was formed at the irradiation finishing position with the laser light (gap width=0 μm). The residual carbon amount in the sealing material layer was measured, whereby it was confirmed to be equal to the residual carbon amount when the coating layer of the same sealing material paste was fired in an electric furnace (at 300° C. for 40 minutes). Further, it was confirmed that no thermal damage or the like was imparted to the color filter formed on the surface of the glass substrate.

Then, the above second glass substrate having the sealing material layer and a first glass substrate (a substrate made of alkali-free glass having the same composition and the same shape as the second glass substrate) having an element region were laminated. In the same manner as in Example 1, then, the laser light was applied through the second glass substrate while scanning along the sealing material layer to melt the sealing material layer and to quench and solidify it to bond the first glass substrate and the second glass substrate. The obtained glass package was confirmed to be excellent in the reliability, the airtightness, the appearance, the bond strength, etc. like in Example 11.

### Comparative Example 1

In the same manner as in Example 1, an alkali-free glass substrate having a frame-form coating layer of the sealing material paste formed thereon, was disposed on a sample holder of a laser irradiation apparatus by means of an alumina substrate having a thickness of 0.5 mm. A laser light having a wavelength of 940 nm and an power density of 736 W/cm² and having a circular beam shape with a diameter of 1.5 mm was applied along the frame-form coating layer of the sealing material paste on the glass substrate. The laser light was applied from the irradiation starting position to the irradiation finishing position at a constant speed of 5 mm/sec. In such a manner, the sealing material layer was formed. The gap width at the irradiation finishing position was as shown in Table 3. In the same manner as in Example 1, the second glass substrate and the first glass substrate were laminated and then the laser light was applied to the sealing material layer through the second glass substrate to bond the first glass substrate and the second glass substrate. As a result, it was confirmed that the bond strength, the airtightness, etc. of the sealing layer were poor as compared with Example 1.

### Comparative examples 2 to 4

A sealing material layer was formed by firing the frame-form coating layer by the laser light in the same manner as in Comparative Example 1 except that the particle shapes or the contents of the cordierite powder and the laser absorbent, the scanning speed with the laser light, the heating temperature of the frame-form coating layer, etc. were changed to the conditions as shown in Table 3. The gap width in the irradiation finishing position was as shown in Table 3. Further, in the same manner as in Example 1, the second glass substrate and the first glass substrate were laminated and then the laser light was applied to the sealing material layer through the second glass substrate to bond the first glass substrate and the second glass substrate. As a result, it was confirmed that the bond strength, the airtightness, etc. of the sealing layer were poor as compared with Example 1.

TABLE 3

| | | | | Comp. | Comp. | Comp. | Comp. |
|---|---|---|---|---|---|---|---|
| | | | | Ex. 1 | Ex. 2 | Ex. 3 | Ex. 4 |
| Sealing | Glass frit | Material | | Bismuth glass | | | |
| material | | Content (vol %) | | 66.9 | 74.6 | 68.3 | 68.3 |
| | | Content (mass %) | | 79.8 | 84.0 | 82.7 | 82.7 |
| | Low- | Material | | Cordierite | | | |
| | expansion | Particle | Average particle diameter (μm) | 0.9 | 0.9 | 1.8 | 1.8 |
| | filler | shape | Specific surface area (m²/g) | 12.4 | 12.4 | 4.3 | 4.3 |
| | | Content (vol %) | | 19.1 | 10.6 | 24.8 | 24.8 |
| | | Content (mass %) | | 8.8 | 4.6 | 11.6 | 11.6 |
| | Laser | Material | | Fe-Al-Mn-Cu-O | | | |
| | absorbent | Particle | Average particle diameter | 0.8 | 0.8 | 1.2 | 1.2 |
| | | shape | (μm) | | | | |
| | | | Specific surface area | 8.3 | 8.3 | 6.3 | 6.3 |
| | | | (m²/g) | | | | |

| | | | | |
|---|---|---|---|---|
| Content (vol %) | 13.9 | 14.8 | 6.9 | 6.9 |
| Content (mass %) | 11.4 | 11.4 | 5.7 | 5.7 |

| | Fluidity-inhibitory factor | 203.7 | 151.7 | 85.8 | 85.8 |
|---|---|---|---|---|---|
| | Thermal expansion coefficient (×10⁻⁷/K) | 80 | 90 | 72 | 72 |
| Dried thickness of frame-form coating layer (μm) | | 14 | 14 | 14 | 14 |
| Laser firing | Scanning speed in scanning region (mm/sec) | 5 | 5 | 5 | 5 |
| conditions | Scanning speed in finishing region (mm/sec) | 5 | 5 | 5 | 5 |
| | Power density (W/cm²) | 736 | 736 | 736 | 623 |
| | Firing temperature (° C.) | 840 | 840 | 830 | 700 |
| Sealing | Thickness (μm) | 8.4 | 8.4 | 8.4 | 8.6 |
| material | Gap width (μm) | 447 | 391 | 317 | 700 |
| layer | | | | | |

From the foregoing, it is considered that good airtightness can be obtained when the gap width in the sealing material layer is at most 270 μm. It is preferably at most 100 μm, further preferably at most 50 μm.

In this specification, the construction of the electronic device of the present invention and the process for producing the electronic device have been described by using an expression of “the first glass substrate” and “the second glass substrate”. In these descriptions, however, the first glass substrate may be substituted by the second glass substrate, or the second glass substrate may be substituted by the first glass substrate, within the concept of the present invention. In the above Examples, a case where one sealing region is provided on a glass substrate, is described, but the present invention is applicable to a case where a plurality of sealing regions are formed on a glass substrate. For example, there may be a case where a total of nine sealing regions are disposed in 3 rows and 3 columns on a glass substrate. In such a case, nine electronic devices may be formed on one glass substrate.

### INDUSTRIAL APPLICABILITY

According to the process for producing a glass member provided with a sealing material layer of the present invention, even in a case where the entire glass substrate cannot be heated, it is possible to form a good sealing material layer at a low cost with good reproducibility, and it becomes possible to inexpensively produce an electronic device excellent in the reliability, the sealing property, etc. Thus, the present invention is useful for the production of a glass package for e.g. a flat display device (FPD) such as an organic EL display, a field emission display, a plasma display panel or a liquid crystal display, an illumination device using a light-emitting element such as an OEL element, or a solar cell.

This application is a continuation of PCT Application No. PCT/JP2012/050108, filed on Jan. 5, 2012, which is based upon and claims the benefit of priority from Japanese Patent Application No. 2011-001290 filed on Jan. 6, 2011 and Japanese Patent Application No. 2011-169072 filed on Aug. 2, 2011. The contents of those applications are incorporated herein by reference in its entirety.

### REFERENCE SYMBOLS

1: First glass substrate, 1a: first surface, 2: second glass substrate, 2a: second surface, 3: element region, 4: electronic element portion, 5: first sealing region, 6: second sealing region, 7: sealing material layer, 8: coating layer of sealing material paste, 9: firing laser light, 10: sealing laser light, 11: sealing layer, 12: electronic device, 21: laser firing apparatus, 22: sample table, 23: laser light source, 24: laser irradiation head, 25: power control part, 26: X stage, 27A, 27B: Y stage, 28: scanning control part.

What is claimed is:

1. A process for producing a glass member provided with a sealing material layer, which comprises:
preparing a glass substrate having a sealing region;
applying a sealing material paste prepared by mixing a sealing material containing a sealing glass and a laser absorbent with an organic binder, to the sealing region of the glass substrate in the form of a frame to form a frame-form coating layer; and
scanning and irradiating with a laser light along the frame-form coating layer of the sealing material paste to heat the entire frame-form coating layer with the laser light thereby to fire the sealing material while burning off the organic binder in the frame-form coating layer to form a sealing material layer;
wherein the scanning speed with the laser light in a finishing region from a position close to an irradiation finishing position which at least partially overlaps with an already fired portion of the frame-form coating layer to the irradiation finishing position, is adjusted to be slower than the scanning speed with the laser light in a scanning region along the frame-form coating layer excluding the finishing region.

2. The process for producing a glass member provided with a sealing material layer according to claim 1, wherein the scanning speed with the laser light in the finishing region is adjusted to be slower at the time when the center of the beam of the laser light has reached a position distant by at least 1.2 times the beam diameter of the laser light from the fired portion of the frame-form coating layer.

3. The process for producing a glass member provided with a sealing material layer according to claim 1, wherein the scanning speed with the laser light in the scanning region is controlled to be within a range of from 3 to 20 mm/sec, and the scanning speed with the laser light in the finishing region is controlled so that the scanning speed at the position distant by at least 1.2 times the beam diameter of the laser light from the fired portion of the frame-form coating layer would be at most 2 mm/sec.

4. The process for producing a glass member provided with a sealing material layer according to claim 1, wherein the irradiation finishing position with the laser light is set within a range from the position which partially overlaps with the fired portion of the frame-form coating layer to a position where an overlapping irradiation region with the laser light would be at most 20 times the beam diameter of the laser light.

5. The process for producing a glass member provided with a sealing material layer according to claim 1, wherein the scanning speed with the laser light in the finishing region is adjusted to be slower within a range distant by at least 1.2 times and at most 20 times the beam diameter of the laser light from the fired portion of the frame-form coating layer.

6. The process for producing a glass member provided with a sealing material layer according to claim 1, wherein the sealing material layer has a thickness of at most 20 μm.

7. The process for producing a glass member provided with a sealing material layer according to claim 1, wherein the frame-form coating layer is irradiated with the laser light so that the heating temperature of the sealing material is within a range of at least (T+80° C.) and at most (T+550° C.) relative to the softening temperature T (° C.) of the sealing glass.

8. The process for producing a glass member provided with a sealing material layer according to claim 1, wherein the sealing material contains from 0.1 to 40 vol % of the laser absorbent and from 0 to 50 vol % of a low-expansion filler within a range of from 0.1 to 50 vol % as the total amount of the laser absorbent and the low-expansion filler.

9. The process for producing a glass member provided with a sealing material layer according to claim 8, wherein a fluidity inhibitory factor of the sealing material as represented by the sum of products of the contents (mass %) and the specific surface areas (m²/g) of the laser absorbent and the low-expansion filler, is at most 300.

10. An apparatus for producing a glass member provided with a sealing material layer, which comprises:
a sample table on which a glass substrate having a frame-form coating layer of a sealing material paste prepared by mixing a sealing material containing a sealing glass and a laser absorbent with an organic binder, is to be placed;
a laser light source to emit a laser light;
a laser irradiation head having an optical system to irradiate the frame-form coating layer of the glass substrate with a laser light emitted from the laser light source;
a power control part to control the power of the laser light to be applied to the frame-form coating layer from the laser irradiation head;
a moving mechanism to relatively change the positional relation between the sample table and the laser irradiation head;
a scanning control part to control the moving mechanism so as to apply the laser light with scanning along the frame-form coating layer and to adjust the scanning speed with the laser light in a finishing region from a position close to an irradiation finishing position which at least partially overlaps with an already fired portion of the frame-form coating layer to the irradiation finishing position, to be slower than the scanning speed with the laser light in a scanning region along the frame-form coating layer excluding the finishing region.

11. The apparatus for producing a glass member provided with a sealing material layer according to claim 10, wherein the scanning control part controls the moving mechanism so that the scanning speed with the laser light in the finishing region is adjusted to be slower at the time when the center of the beam of the laser light has reached a position distant by at least 1.2 times the beam diameter of the laser light from the fired portion of the frame-form coating layer.

12. The apparatus for producing a glass member provided with a sealing material layer according to claim 10, wherein the scanning control part controls the moving mechanism so that the scanning speed with the laser light in the scanning region would be within a range of from 3 to 20 mm/sec, and the scanning speed with the laser light in the finishing region would be at most 2 mm/sec at the position distant by at least 1.2 times the beam diameter of the laser light from the fired portion of the frame-form coating layer.

13. A process for producing an electronic device, which comprises:
preparing a first glass substrate having a first surface having a first sealing region provided thereon;
preparing a second glass substrate having a second surface having a second sealing region corresponding to the first sealing region provided thereon;
applying a sealing material paste prepared by mixing a sealing material containing a sealing glass and a laser absorbent with an organic binder to the second sealing region of the second glass substrate in the form of a frame to form a frame-form coating layer;
scanning and irradiating with a firing laser light along the frame-form coating layer of the sealing material paste to heat the entire frame-form coating layer with the laser light thereby to fire the sealing material while burning off the organic binder in the frame-form coating layer to form a sealing material layer;
laminating the first glass substrate and the second glass substrate via the sealing material layer so that the first surface and the second surface face each other; and
irradiating the sealing material layer with a sealing laser light through the first glass substrate or the second glass substrate to melt the sealing material layer thereby to form a sealing layer to seal an electronic element portion provided between the first glass substrate and the second glass substrate;
wherein irradiating the sealing material layer, the scanning speed with the laser light in a finishing region from a position close to an irradiation finishing position which at least partially overlaps with an already fired portion of the frame-form coating layer to the irradiation finishing position, is adjusted to be slower than the scanning speed with the laser light in a scanning region along the frame-form coating layer excluding the finishing region.

14. The process for producing an electronic device according to claim 13, wherein the scanning speed with the firing laser light in the finishing region is adjusted to be slower at the time when the center of the beam of the laser light has reached a position distant by at least 1.2 times the beam diameter of the firing laser light from the fired portion of the frame-form coating layer.

15. The process for producing an electronic device according to claim 13, wherein the scanning speed with the firing laser light in the scanning region is controlled to be within a range of from 3 to 20 mm/sec, and the scanning speed with the firing laser light in the finishing region is controlled so that the scanning speed at the position distant by at least 1.2 times the beam diameter of the laser light from the fired portion of the frame-form coating layer would be at most 2 mm/sec.
